(19) United States
(12) Patent Application Publication
(10) Pub. No.: US 2025/0093060 A1
(43) Pub. Date: Mar. 20, 2025

(54) HVAC SYSTEM WITH WIND TURBINES TO GENERATE AND HARVEST ENERGY

(71) Applicant: Soojung Ham, Providence, RI (US)

(72) Inventor: Soojung Ham, Providence, RI (US)

(21) Appl. No.: 18/829,410

(22) Filed: Sep. 10, 2024

Related U.S. Application Data
(60) Provisional application No. 63/582,693, filed on Sep. 14, 2023.

(51) Int. Cl. F24F 11/46; F03D 9/11; F03D 9/45; F24F 120/10

(52) U.S. Cl. CPC F24F 11/46; F03D 9/11; F03D 9/45; F24F 2120/10

(57) ABSTRACT

The heating, ventilation and air conditioning system of the present invention includes air delivery modules that an air flow housing with an impellor blade located therein. Air passing through the housing creates electricity which can be stored in an energy storage device. An individual presence sensor is electrically interconnected to and powered by the energy storage device. The modules are mounted via a pan and tilt mechanism whereby servo motors attached thereto direct the output of the modules in response to individual presence sensor data to turn and/or direct air toward the individual. The system provides a self-powered system that provides controlled flow and direction of air to provide a custom heating, ventilation and air conditioning system.

### CROSS-REFERENCE TO RELATED APPLICATION

This patent document claims priority to earlier filed U.S. Provisional Patent Application Ser. No. 63/582,693, filed Sep. 14, 2023, the entire contents of which are incorporated herein by reference.

### BACKGROUND OF THE INVENTION

The present invention relates to the field of creating electricity from wind turbines and storing such created electricity. The present specifically relates to the use of wind turbines in smaller, more confined spaces, such as interior space or environment. Such an interior space or environment may include an office space, industrial manufacturing area or residential space, for example. The present invention further relates to a wind energy harvesting system to be employed in a heating, ventilation, and air conditioning (HVAC) system in the roof or ceiling area of certain types of environments, such as interior environments. The invention relates to the use of turbines to convert wind associated with air flow within the HVAC system into electricity that can, in turn be used for operation of the HVAC system itself.

The system relates to the collection, storage, and application of wind energy which may be used to create electricity to operate an HVAC system, such as a system that has sensors and other devices that can alter the HVAC system based on human activity in such an interior environment.

By way of further background, there has been a rise in attention and a maturation of renewable energy that is based on exterior wind turbine energy harvesting. However, there has been little or no development of this general technology to harvesting energy from wind that is generated in interior and confined spaces such as from existing HVAC systems, namely systems that include forced flow of heated or cooled air. Therefore, there has been significant challenges in effectively collecting wind energy in interior spaces resulting in few solutions in this field.

In interior spaces, there can be significant volumes of air flow, namely air flow in the HVAC system when it delivers forced hot air (for heating a space) or forced cold air (for air conditioning a space) through registers located throughout the space. There are return vents that return such circulated air back to the source of the generation of heat or cooling for typical continual re-heating or re-cooling the forced air to provide the desired respective heating or cooling of the space. Air flow in the HVAC system can be converted to electricity by wind turbines for use to operate the HVAC system. Frequently, such air flow is more than sufficient to circulate the heated or cooled air for this purpose resulting in excess air flow which is completely unused. Such air flow and excess air flow could and the electricity created therefrom can be used for powering other devices outside the HVAC system or provide electricity back to the grid.

There have been some attempts in the prior art and in the renewal energy industry to utilize this unused or excess air flow. Existing strategies attempt to provide and improve the efficiency of interior “small” wind collection using some type of mechanism for wind energy collection with a circuit, or the like.

For example, “galloping” energy harvesters an advantage due to its self-excited and self-limited characteristics of galloping, where it has a large oscillation amplitude, and can oscillate with an infinite range of wind speeds. However, these devices and systems suffer from the disadvantage of requiring high wind specific. For example, most piezoelectric aeroelastic energy harvesters operate effectively only at high wind speeds or within a narrow speed range. In another attempt in the industry, “fluttering” energy harvesters collect air flow and/or ambient air has also become a popular direction.

However, both the fluttering and galloping mechanism oscillate and generate energy only in laminar flow conditions, which are usually not the case in natural environments where turbulence commonly exists thus stabilizing the harvesters. Also, such known devices and systems require a cut-in speed as the minimum limit of wind speed, below which no power can be generated. Such requirements are not acceptable in very small-scale wind turbine systems, especially in interior environments.

Also, turbulence-induced vibrations (TIV) may offers an advantage as it never vanishes, even under small average wind speeds. However, such technology may be difficult to implement in practice in closed interior environments.

There is a need in the industry that can address the foregoing problems and shortcoming in known small-scale turbine systems that are to be used in interior environments.

There is a further need for a system that integrates with an existing HVAC system to harvest air flow being generated therefrom and convert it to usable energy, such as electricity, for use for operation of the HVAC system and the sensors and devices used therein.

There is a need for a system that integrates directly into the air delivery system that routes air into a given space.

There is a further need to be customize the direction, volume, and flow of air into a given space upon human presence in a given space.

There is a particular need for such a system that has individual air delivery exit port units that independently controllable so the direction of flow of air flow therefrom can be directed to a specific desired location.

There is a further need for a system to control individual air delivery exit port units in an efficient and cost effective manner with as few moving parts and components as possible.

There is a need for on demand control of individual air delivery exit port units into the space.

There is a need to provide a modular system of individual air delivery exit port units that can be scaled up or down to meet the needs of a given space.

### SUMMARY OF THE INVENTION

The objective of the present invention is to provide a new and unique HVAC system that delivers air flow to different locations in an interior space, where the air delivery exit port units are configured as “smart” registers that can control the flow and direction of air at each exit port individually where such flow is optionally and preferably controlled based on human presence in the area of the port. Also, each exit port unit is equipped with a turbine, through which air flows, to convert the air flowing therethrough into electricity for use by the respective devices, such as sensors and servo motors, within the exit port at which the turbine is installed and located. Such electricity is preferably stored locally at each exit port, such in a battery associated with the respective exit port unit. Excess electricity that is not needed to power the respective devices at the exit port may be used for other devices in the space, such as lighting. The excess electricity may also be sold back to the grid or stored at another remote location.

The stored electricity in the battery for each exit port unit is preferably used to assist in operation of the HVAC system, namely, the operation of a given local exit port. For example, the electricity created by the turbine may be used to operate a valve to control flow of air through that port unit or for other devices, such as servos and sensors. For example, the locally stored electricity can power ambient or presence sensors that detect the presence of an individual near the particular air delivery exit port. For example, air flow may be turned on at that particular air delivery exit port when the sensor detects the presence of a person in the space. Also, the created electricity may power servo motors that control the direction of a nozzle at the exit port. The sensors may detect the location of human presence in three-dimensional space and then convey that information to the control system to, in turn, instruct the servo motors to cooperatively move the nozzle toward the location of the person detected to optimize and increase the energy efficiency of the HVAC.

The air delivery exit port units are preferably wirelessly networked to each other, such as by Bluetooth, Wi-Fi, or the like so they may communicate with each other. This further enables remote control of the entire network of port units from a central location, such as a central controller, hub, router, device, or the like. For example, such remote control may be carried out by a mobile device or computer either directly to each of the modules 12 or via a central hub, and the like.

In an alternative embodiment of the present invention, it is also possible to electrically interconnect the port units to a central location so excess electricity not used locally for operation of the exit port can be used for other power needs. In other words, the entire network of air delivery port units can also be used for electricity generation for the electrical needs of the environment, such as lighting and other non-HVAC sensors or sale of the excess electricity back to the grid.

The wind energy harvesting system of the present invention is employed in the HVAC system, preferably in the roof or ceiling area of interior environments. The enables the collection, storage, and application wind energy based on human activity within the environment.

Further air amplifies may be employed at each air delivery exit port unit to further enhance and make more efficient air flow at each port. As can be understood, improved air flow and efficiency of delivery of such air flow is desirable and such an air amplifier is desirable for such purpose.

Therefore, an object of the present invention is address the foregoing problems and shortcoming in known small-scale turbine systems that are to be used in interior environments.

There is a further object of the present invention to provide a system that integrates with an existing HVAC system to harvest air flow being generated therefrom and convert it to usable energy, such as electricity, for use for operation of the HVAC system and the sensors and devices used therein.

Yet another object of the present invention is to integrate the creation of electricity by air turbines into the air delivery system that routes air into a given space.

A further object of the present invention is to provide a system that can provide on-the-fly control of the direction, volume, and flow of air into a given space upon human presence in a given space, all using electricity created locally by a wind turbine.

Still a further object of the present invention is to provide control of individual air flow ports into the space.

Another object of the system of the present invention is to provide individual air delivery exit port units that are independently controllable so the direction of flow of air flow therefrom can be directed to a specific desired location.

Another object of the system of the present invention is to control the individual air delivery exit port units in an efficient and cost effective manner with as few moving parts and components as possible.

There is yet another object of the present invention to provide a modular system that can be scaled up or down to meet the needs of a given space.

Another object of the present invention is to provide a HVAC system that creates additional electricity that can be used to power devices outside the HVAC system or provide electricity back to the grid.

Yet another object of the present invention is to provide air flow at each air delivery exit port unit that is amplified and enhanced for improved efficiency and flow of delivered air to optimize the overall performance of the present system.

Therefore, the present invention provides a new, unique and novel HVAC system that uses forced hot or cold air to condition an interior environment, such as an office space, whereby such air flow also powers devices located at a given exit port location or locations are otherwise not proximal or interconnected to a source of electricity.

### BRIEF DESCRIPTION OF THE DRAWING FIGURES

Further advantages, features and possible applications of the present invention are shown and described in the accompanying drawing figures.

FIG. 1 is a top perspective view of HVAC system of the present invention installed in an environment with users present therein;

FIG. 2 is a top perspective view of the HVAC system of the present invention installed in an environment with no individuals present therein;

FIG. 3 is a bottom perspective view of the HVAC system of the present invention installed in an environment;

FIG. 4 is a top schematic view of HVAC system of the present invention showing the coverage of individual air delivery modules within a given environment;

FIG. 5 is a side elevational view of the HVAC system of the present invention showing the downward coverage of individual air delivery modules within a given environment;

FIG. 6 is a perspective view of an air delivery module in accordance with the present invention;

FIG. 7 is a top view of the air delivery module of FIG. 6;

FIG. 8 is a top view of the air delivery module of FIG. 7 showing the panning capability thereof;

FIG. 9 is a side elevational view of the air delivery module of FIG. 6;

FIG. 10 is a side elevational view of the air delivery module of FIG. 9 showing the tilting capability thereof;

FIG. 11 shows a bottom perspective view of the turbine portion of the air delivery module;

FIG. 12A shows a top perspective view of the blower portion of the air delivery module;

FIG. 12B shows a top perspective view of the blower portion of the air delivery module with top cover removed for illustration purposes to show the magnets;

FIG. 12C shows a top perspective view of the blower portion of the air delivery module with top cover and turbine blade removed for illustration purposes;

FIG. 13A shows a bottom top perspective view of the blower portion of the air delivery module with the turbine blade and bottom housing removed for illustration purposes to show the wire windings;

FIG. 13B shows a bottom perspective view of the blower portion of the air delivery module with the bottom housing removed for illustration purposes to show the turbine blade;

FIG. 13C shows a bottom perspective view of the blower portion of the air delivery module;

FIG. 14 is a side cross-sectional view of the blower portion of the air delivery module using an air amplifying configuration;

FIG. 15 shows a schematic view of the blower portion of FIG. 14 using an air amplifying configuration;

FIG. 16 is a perspective view of a further embodiment of the air delivery module of the present invention with rechargeable batteries for energy harvesting;

FIG. 17 is a side elevational view of the further embodiment of the air delivery module of the present invention of FIG. 16;

FIG. 18 is a top perspective view of a further embodiment of the air delivery module with an array of sensors for air flow directional control; and

FIG. 19 is a top perspective view of sensor network communication components.

### DESCRIPTION OF THE INVENTION

The system 10 of the present invention provides a new and novel HVAC system 10 with an array of individually air delivery modules 12 with direction-controllable air blowers in response to environmental events, such as presence of a person therein, or other instruction provided to the system 10. This enables on-the-fly custom directional delivery of HVAC air flow into the room environment 14 in response to the sensing of the presence and location of an individual 16 in the room environment 14 or other instruction.

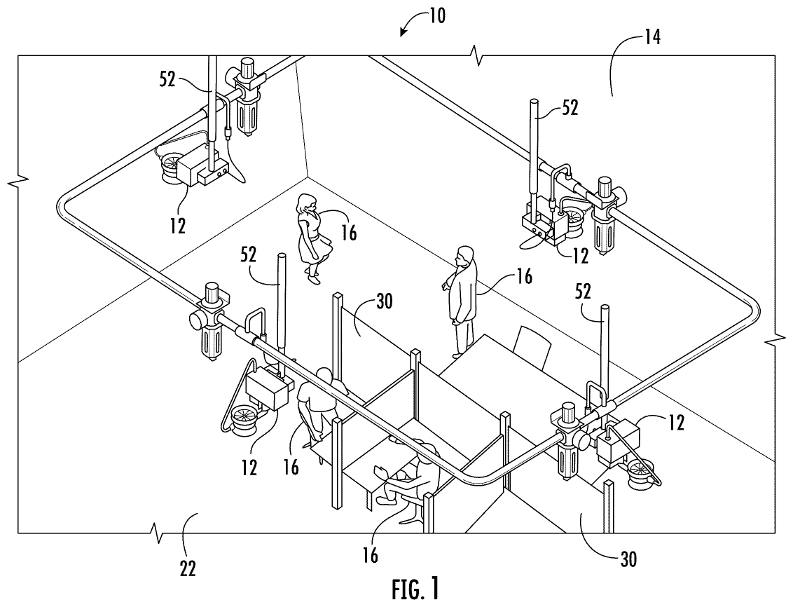

Turning first to FIGS. 1-5, different view of the overall HVAC system 10 of the present invention is shown with an array of air delivery modules 12 that are preferably suspended from a ceiling 18 in the environment/room 14 to direct air, such as heated or cooled air into the space 14 of the environment. It should be noted that while it is preferred to suspend the system 10 of the present invention from a ceiling 18, it is also possible to mount the system 10 on walls 20 or the floor 22 or they may be free standing in the environment room 14. In general, the air delivery modules 12 of the entire array of modules 12 is positioned in an interior space 14, such a work space that is, for example, intermittingly occupied by individuals 16.

Referring first to FIG. 1, the system 10 of the present invention is shown installed from the ceiling 18 whereby, for example, four air deliver modules 12 are provided in spaced apart relation throughout the room environment 14 where desired. In this example in FIG. 1, the system 10 is arranged in a substantially rectangular configuration with an air delivery module 12 located in the middle of each side of a rectangle defined by air supply conduit 24. In general, the system 10 includes the array of the mounted air delivery modules 12 that each receive compressed air from a remote air supply source 26 via conduit 24 to connector conduit 28 at each air delivery module 12. This supply of air, which has been heated or cooled as desired, is routed to each air delivery module 12, as can be seen in FIG. 1.

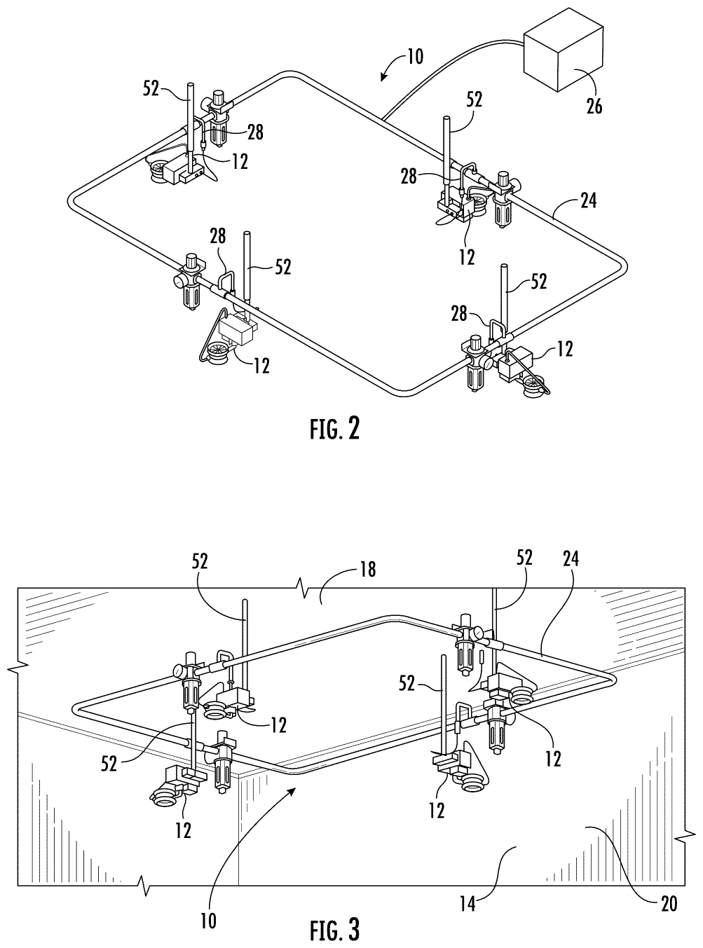

It is also preferred that the layout of the air delivery modules 12 is customized to fit a given environment 14 to best accommodate HVAC air flow for the particular objects 30 and individuals 16 in that environment 14. For example, if there are seven work areas and three hallways and one common area, a total of eleven air delivery modules 12 may be provided directly above those areas in a given workspace 14 with the intention of enabling the system 10 of the present invention to provide HVAC air flow in a controlled manner to those areas 14 that are in need of HVAC control. This configuration is modular and it can be scaled up or down. FIG. 2 shows the perspective view of FIG. 1 with the individuals 16 and objects 30 removed from the room environment 14 for illustration purposes and ease of view of the system 10 of the present invention. FIG. 3 shows an embodiment of the present invention that is ceiling mounted.

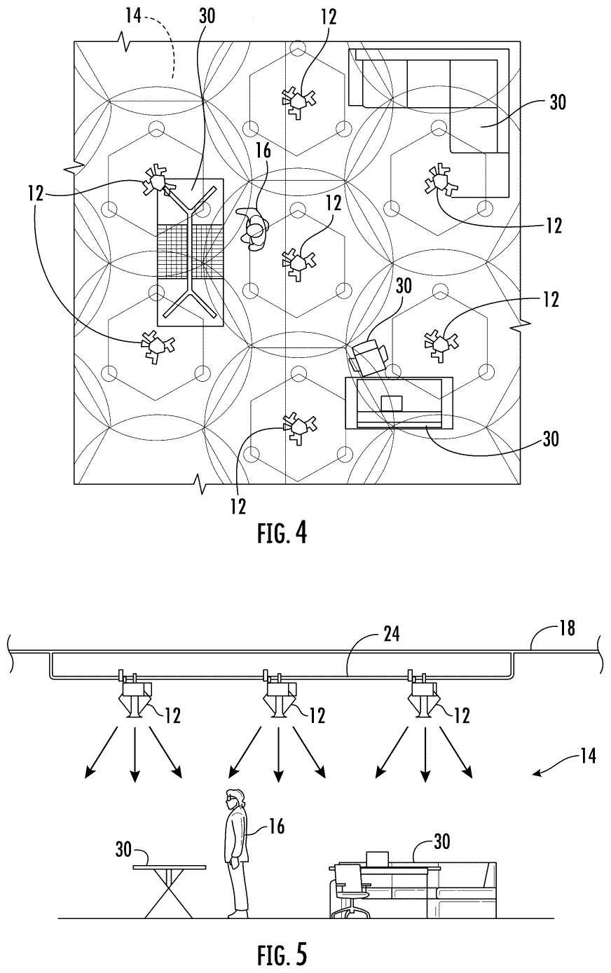

Referring now to FIGS. 4 and 5, further detail and possible design of the layout and arrangement of the individual air delivery modules 12 are shown. For example, in FIG. 4, the individual air delivery modules 12 can be configured and arranged from a plan view standpoint as needed for a given interior space 14 where the coverage of given air delivery modules 12 can be mapped out and arranged so the array, as a whole, meets the needs of a given installation space 14 and the individuals 16 that will occupy it. FIG. 5 shows positioning of air delivery modules 12 from above to further illustrate the given coverage of a given array of air delivery modules 12. FIG. 5 shows, from an elevational view how the modules 12 can be arranged in the ceiling 18 to be proximal (i.e., above) high traffic areas where individuals 16 might reside during the work day. It should be understood that the air flow modules 12 may be populated in sufficient density and spacing so that air flow can be provided as needed throughout the day.

While an array of four air delivery modules 12 are shown in FIGS. 1-3, seven modules are shown in FIG. 4 and three are visible in FIG. 5, any number of air delivery modules 12 may be used to suit the application and room environment 14 at hand.

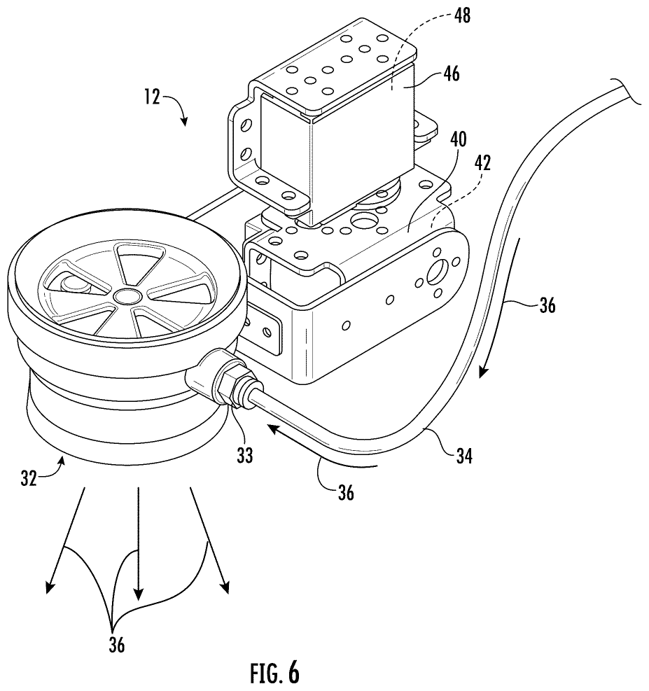

Turning now to FIGS. 6-10, details of the positional and directional control of an individual air delivery module 12, namely the air blower portion thereof 32, is shown in detail. In general, it is preferred that each of the air delivery modules 12 are of the same construction within a given array of air delivery modules 12 for ease of configuration and implementation of the system 10 and control thereof. However, it is possible that the air delivery modules 12 are different (e.g., different air flow rate, different dispersion field, and blower design). For example, if a given area of the room environment 14 has a higher ceiling 18, the air delivery module 12 in that area might be provided with a stronger blower 32 with a higher air flow rate to accommodate that given area 14. For ease of illustration, one air delivery module 12 will be discussed in detail. It should be understood that other air flow modules 12 are preferably of the same construction and operation.

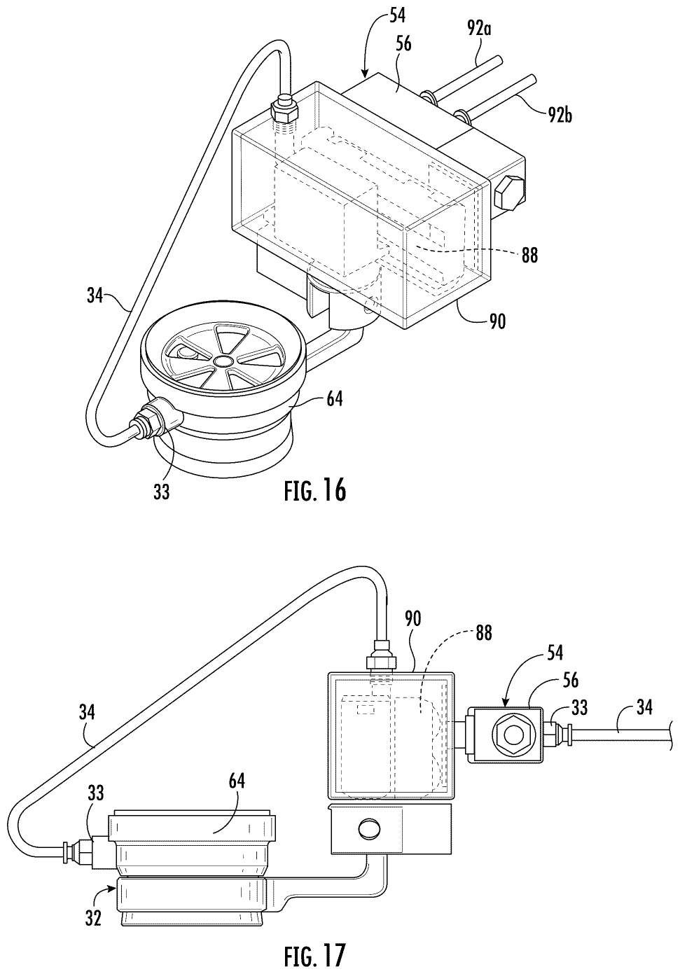

Referring to FIG. 6, a perspective view of an air delivery module 12 in accordance with the present invention is shown in detail. The air delivery module 12 generally includes an input 34 that feeds supplied air 36 into to the air blower 32 via port 33 whereby the blades therein turn creating electricity by the electromagnetic bearings. Detail of the energy harvesting capability of the present invention is shown in FIGS. 16 and 17 discussed below. The supply of air 36 from the air supply line 34 causes the turbines in the air blowers 32 to rotate thereby blowing air 36 downwardly out of the air blower portion 32 of the air delivery module 12.

The air delivery module 12 preferably provides pan and tilt control of each respective air blower portion 32 of a given air delivery module 12. In FIG. 6, the blower 32 is connected to a bracket 38 that is rotatably connected to a first housing 40 with a first servo motor 42 therein to control tilt action/rotation about a horizontal spindle 44. The first housing 40 is in turn rotatably mounted to a second housing 46 with a second servo motor 48 therein to control pan action/rotation about a vertical spindle 50. The second housing 46 is mounted to a support, such as the ceiling mounted pole supports 52 shown in FIGS. 1-5, or directly to a ceiling 18, wall, or the like. Thus, in combination, the first servo motor 42 and second servo motor 46 work together to direct the air blower 32, namely its output which faces generally downward, in any desired direction using a pan and tilt mounting interface.

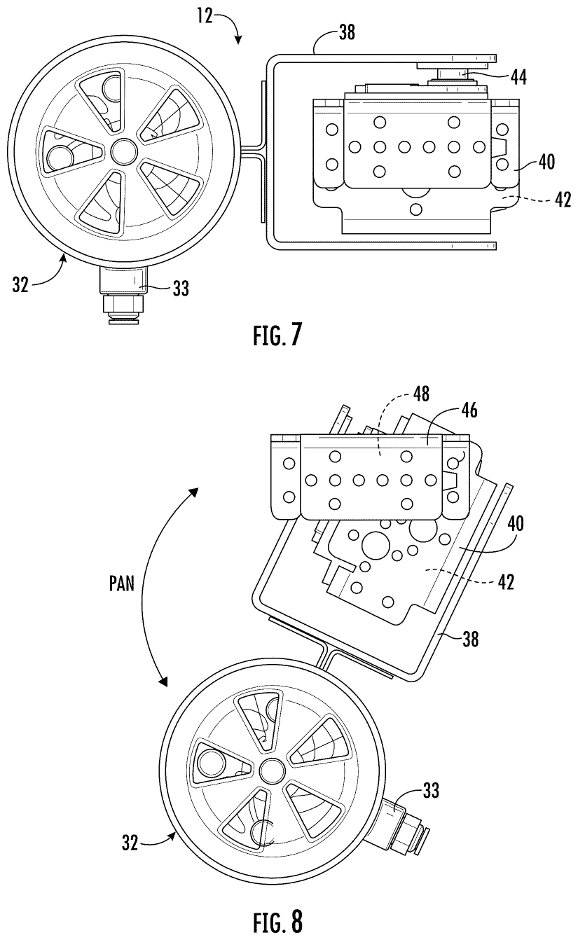

FIG. 7 provides a top view of the air delivery module 12 of FIG. 6 while FIG. 8 shows a top view of the air delivery module 12 of FIG. 7 showing the panning capability of the air delivery module 12 about the vertical servo-controlled spindle 50. The interconnection of the air blower 32 to the first housing 40 via a bracket 38 can be seen therein. The second servo motor 48 is interconnected to the vertical spindle 50 to control the rotation thereof, namely, the panning of the air blower portion 32 of the air delivery module 12. FIG. 8 shows the panning action from the actuation about vertical spindle 50. Thus, the vertical spindle 50 and the associated panning can be actuated back and forth incrementally or fully, as desired. It should be noted that the internal details of interconnection of a spindle 50 to a given servo motor 48 is not shown for ease of illustration. However, the control of a spindle 44, 50 by a servo motor 42, 48 is so well known in the art that it need not be discussed in detail herein.

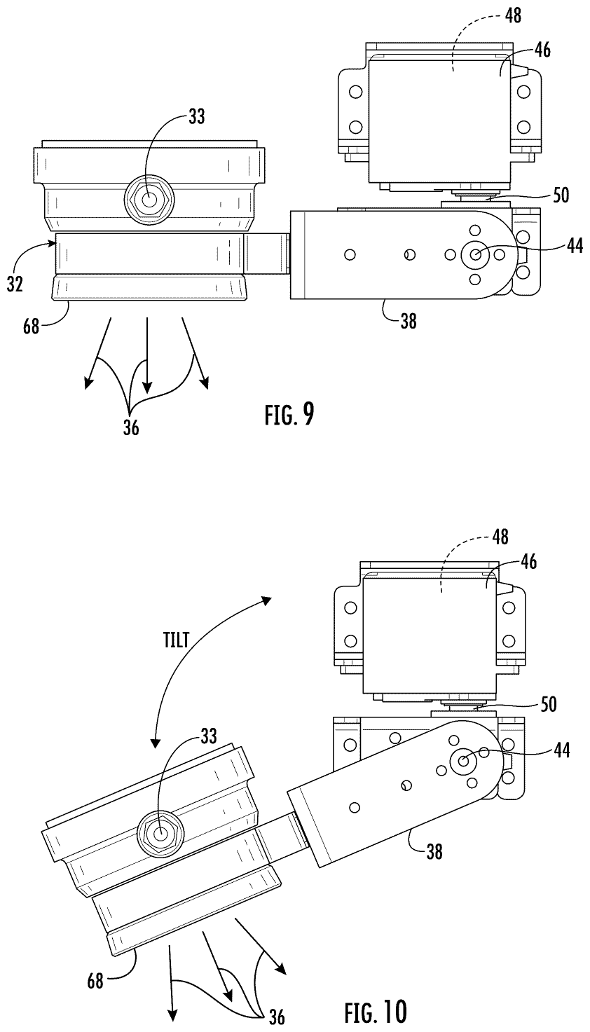

FIGS. 9 and 10 show the tilting capability of the air blower portion 32 of the air delivery module 12 of the present invention. FIG. 9 shows a side elevational view of the air delivery module 12 of FIG. 6 while FIG. 10 shows a side elevational view of the air delivery module 12 of FIG. 9 showing the tilting capability. The air blower 32 is connected to the first housing 40 with a first servo 42 therein via the bracket 38 and first (horizontal) spindle 44. Actuation of the first spindle 44 back and forth causes the air blower portion 32 to tilt up and down to thereby control angular direction of the flow of air 36 from the air delivery module 12. Similar to the second servo 48 and vertical spindle 50, the first servo 42 and the horizontal spindle 44 and the associated tilting can be actuated up and down incrementally or fully, as desired.

Therefore, supply of air 36 (either heated, cooled, or otherwise) is directed into the air delivery module 12 via conduit 34 and out through the air blower portion 32 to deliver such air 36 into the room environment 14. With the pan and tilt capability, the direction of flow of air 36 can be precisely directed and controlled to optimize air flow into a given space 14. For example, input of the supply air 36 via conduit 34 may be first controlled by a valve 56, such as a solenoid valve within a manifold 54, as seen in FIGS. 16 and 17. The solenoid valve 56 is preferably controlled by one or more sensors, as will be discussed further below. For example, depending on programming of the system 10 of the present invention, the solenoid valve 56 can be closed when it does not sense presence of an individual 16 nearby and can be open when the sensor does sense presence of an individual 16 nearby for energy efficiency and reduction of cost of operation. As also will be discussed below, various sensors 58 may be used to track the location of objects 30 in a room, such as individuals 16, whereby the air delivery module 12 actuates the appropriate servo motors 42, 48 to, in turn, invoke a pan and tilt directional control of the air blower 32 to direct flow of air 36 precisely where desired. Such movement of the air blower 32 is shown, by way of example, in FIGS. 8 and 10 below to create many combinations of directions to which the air blower 32 can be aimed.

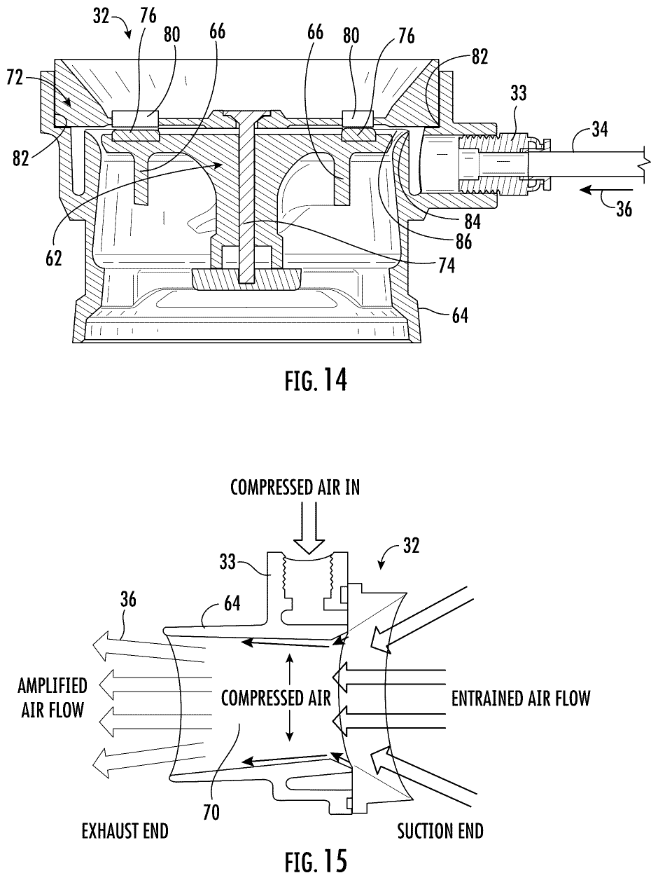

FIG. 11 shows a bottom perspective view of the turbine portion 60 of the air delivery module 12. An impellor blade 62 is rotatably mounted to the air blower housing 64. Blades 66 are provided on the impellor blade 62, preferably in an arcuate configuration. Thus, when air 36 is delivered through the housing 64 and into communication with the blades 66 of air blower 60, the impellor blade 62 will rotate thereby, in turn, directed air 36 now downwardly toward the room environment 14. Thus, the configuration of the air blower 32 shown in FIG. 11 effectively translates air from the main line 34 of compressed air 36 to a downward direction into the room environment 14. With the aforesaid pan and tilt functionality, the direction of the downward directed flow of air 36 from the air blower 32 and out its exit port 68 can be further and more precisely controlled. FIG. 14, which will be discussed in more detail below, provides additional details of the construction of the air blower 32 with air amplification.

It should be noted that the pan and tilt mechanism for directing the air flow of the air blower 32 into the environment 14 is a preferred configuration. Other mechanisms and configuration, such as servo controlled armatures and the like, are possible and considered within the scope of the present invention.

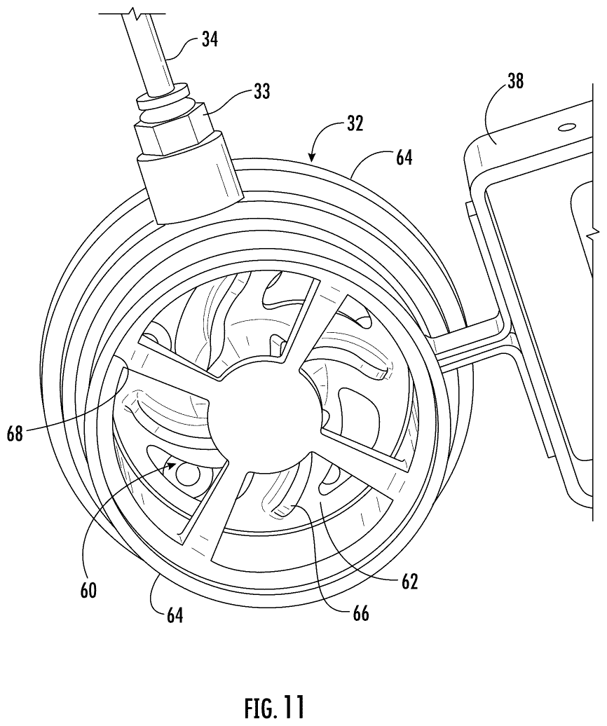

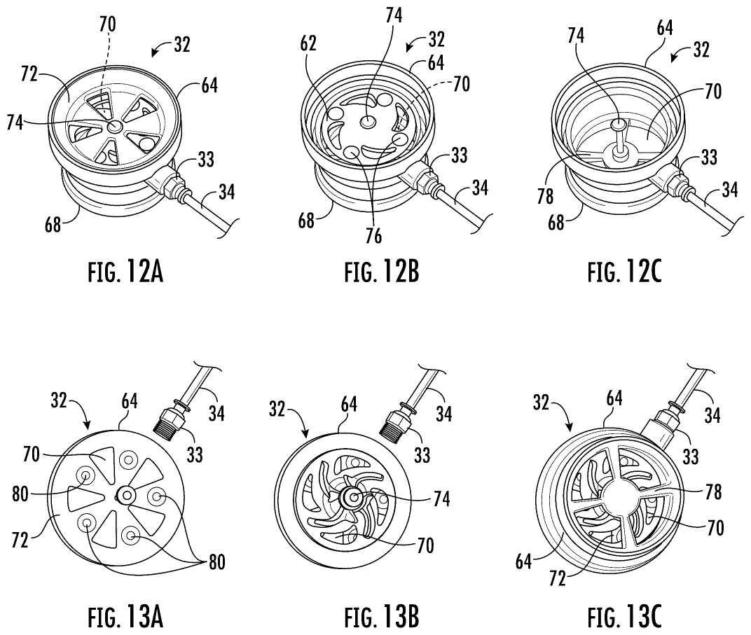

Details of the construction of the air blower portion 32 of the air delivery module is shown in FIGS. 12A-C, 13A-C, 14, and 15.

FIG. 12A shows a top perspective view of the blower portion 32 of the air delivery module 12 where an air supply conduit 34 is connected to the housing 64 and is in fluid communication with an open chamber 70 therein. A top cover 72 is fixed to the housing 64 via a center spindle 74. In FIG. 12B, the top cover 72 is removed for illustration purposes to reveal a rotating impellor blade 62 which carries magnets 76 on the top surface thereof. FIG. 12C further shows the impellor blade 62 also removed for illustration purposes to reveal the center spindle 74 mount emanating upwardly from a bottom support structure 78.

FIG. 13A shows a bottom perspective view of the top cover 72 of the air blower portion 32 of the air delivery module 12 with the impellor blade 62 and housing 64 removed for illustration purposes to show the wire windings 80 on the bottom of the top cover 72. FIG. 13B shows a bottom perspective view of the air blower portion 32 of the air delivery module with the housing 64 removed for illustration purposes to show the impellor blade 62 mounted on the center spindle 74. FIG. 13C shows a bottom perspective view of the air blower portion 32 of the air delivery module 12 showing the housing 64 in place about the top cover 72 and impellor blade 62 with bottom support structure 78 in place.

FIG. 14 is a side cross-sectional view of the air blower portion 32 of the air delivery module, through the line 14-14 of FIG. 12A using the air amplifying configuration. In this view, the stacked components can be easily seen where the housing supports 64 the center spindle 74 which rotatably carries the impellor blade 62, which carries an array of magnets 76. The top cover 72, with wire coils 80 mounted thereto, is secured to a top seat 82 of the housing 64. The magnets 76 on the impellor blade 62 are circumferentially aligned with the coils 80 on the top cover 72. When the wire coils 80 and magnets 76 pass by each other when the impellor blade 62 rotates within the housing 64, the appropriate creation of electricity is carried out. Such a creation of electricity using magnets 76 and wire coils 80 is so well known in the art that further details of this process need not be provided herein. It should also be noted that the magnets 76 and wire coils 80 can be reversed in position where the top cover 72 carries the magnets 76 and the top of the impellor blade 62 carries the coils 80 with additional electrical interconnections required.

Still referring to FIG. 14, the air supply line 34 is interconnected to the housing 64 via port 33 so the introduced air 36 is in fluid communication with the inner chamber space 70 of the housing 64 where the air 36 flows up an over a top inner edge 84 of the housing 64 via an air gap 86 and into communication with the impellor blade 62 to rotate it for electricity/energy harvesting and then, in turn, directing the air 36 downwardly into the room environment 14. FIG. 15 shows a schematic view of the air blower 32 of FIG. 14 using an air amplifying configuration where compressed air 36 is supplied into the housing 64 and entrained air flow from a suction end is carried out to urge air flow into a main cavity 72 of the housing 64 where it is compressed and then urged further downward for effective amplified air flow.

FIGS. 16 and 17 show a further embodiment of the air delivery module 12 of the present invention where the created electricity created from the interaction between the magnets 76 and wire coils 80 is directed to rechargeable batteries 88 for energy harvesting. FIG. 16 shows a perspective view of the embodiment of the present invention where the rechargeable batteries 88 are located inside an electronics housing 90, which are electrically interconnected to the coil wire windings 80. FIG. 17 is a side elevational view of this further embodiment of the air delivery module 12 of the present invention of FIG. 16 where electronics, including the rechargeable batteries 88, are housed in housing 90. The rechargeable batteries 88 serve as an electricity/energy storage device. For such energy storage, individual battery compartments for each module 12 could be added to create a better user experience. For example, the recharged battery 88 supplies the power (for example, 3V-12V) to devices, such as the solenoid device 56, the servos 42, 48, and any other local peripheral devices.

For ease of illustration, the electrical wiring from the air blower 32 to the rechargeable batteries 88 is not shown.

FIGS. 16 and 17 are also show a further embodiment of the present invention where a manifold 54 is provided with solenoid valve control 56 when more than one air supply line 92a, 92b is provided. In the example of FIGS. 16 and 17, a first supply line 92a for hot air and a second supply line 92b for cold air 36 are provided where both are directed into the manifold 54 where the valve 56, e.g., a solenoid valve, is provided to control the flow and mixture of air 36 into the housing 64 from the supply lines 92a, 92b. In particular, the manifold 54 and solenoid valve 56, which is preferably electrically powered by the stored electricity in the rechargeable batteries 88, controls the mixture of hot air and cold air from the respective two supply lines 92a, 92b. For example, the hots supply line 92a or the cold supply line 92b can be selectively turned on or off. Or, a partial mixture of the hot supply line 92a and cold supply line 92b can be provided for precise temperature control in similar fashion to a thermostatic water valve. Also, this embodiment employs another version of the pan and tilt mechanism but the functionality is the same as above in FIGS. 6-9 so it need not be discussed further in connection with FIGS. 16 and 17.

It should be understood that more than two supply lines can be controlled in the same fashion. FIG. 6, for example, shows an embodiment of the invention with a single air supply line 34 so the manifold 54 and solenoid valve 56 are not needed in that embodiment.

The present invention uniquely provides an array of air delivery modules 12, each of which have a directable air blower 32 via the servo-powered pan and tilt mechanism. These air blowers 32 can be adjusted in real-time to change the direction of airflow therefrom into a given room environment 14. The present invention preferably actuates the air blowers 32 in response to presence of an individual 16 in a given room environment 14. The system 10 can be configured to turn on air flow when the presence of an individual 16 is sensed. Also, the system 10 of the present invention may be configured to direct all air blowers 32, within a given distance from the individual 16, to that individual 16 for efficient cooling or heating the environment 14 proximal to the individual 16 thereby avoiding heating up or cooling up the entire room environment 14. In other words, the use of sensors 58 for the air blowers 32 in the room environment 14 can not only determine whether to turn on of off a given air blower 32 but also to track a given individual 16 in the room environment 14 and direct air flow directly at that individual 16.

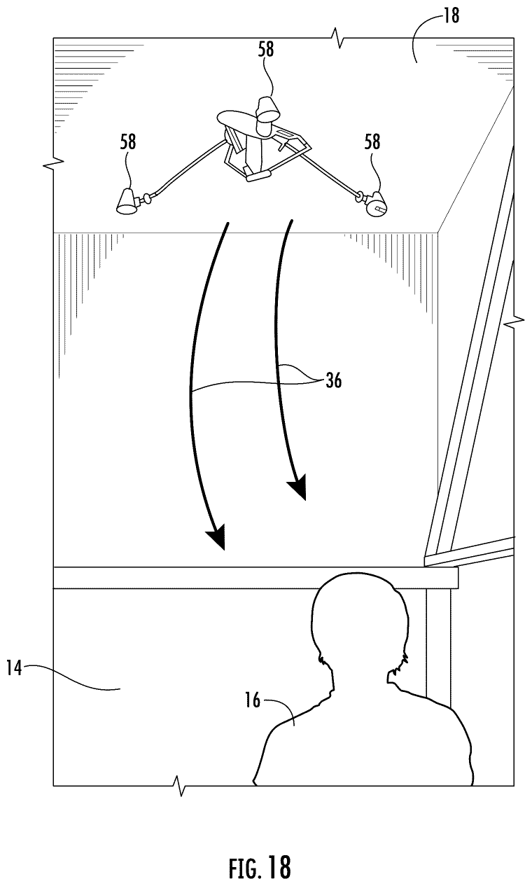

Such tracking is preferably carried out by proximity sensors 58 electrically connected to and near each air delivery module 12 in the room environment 14. FIG. 18 shows an example of such an array of sensors 58 at one of the air delivery module 12 locations. Preferably, three sensors 58, such as passive infrared (PIR) sensors, and two servo motors 42, 48 in the pan and tilt mechanism that work together. The sensors 58 may be any other type of sensor, such as visible light camera, LIDAR, RADAR, mmWave sensors, and the like. The use of three sensors 58 enable sufficient tracking of an individual 16 in the three dimensional space in the vicinity of the air delivery module 12 at hand but more or less than three sensors 58 may be used. Thus, in one embodiment, via the pan and tilt mechanism, the servo motors 42, 48 point the air blower 32 to the point in three dimensional space 14 where the individual 16 has been located by the sensors 58. Uniquely, such presence sensing and adjustment of the target direction of air blowers 32 can be carried out in real time as the individual walks through the room environment 14.

Therefore, directional control of the output air 36 direction in the three dimensional space 14 can be controlled by the present invention where the sensors sense individual presence and the data of which is parsed to instruct the servo motors 42, 48 to move air blower position for custom air control of the direction of air flow.

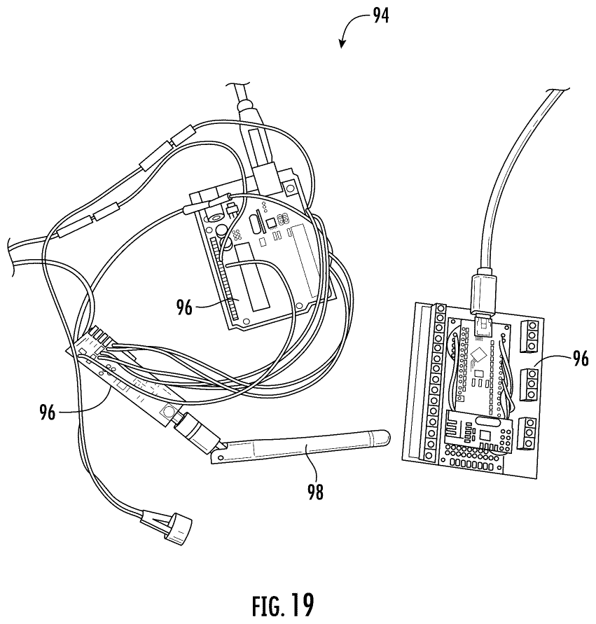

FIG. 19 shows a sensor network and wireless communication module 94 (exploded for illustration purposes) that is preferably included with each air delivery module 12 located within the space 14. Various circuit boards 96 with antenna 98 are employed. The sensor network among transceivers communicates by sending comments/instructions to each or via a central hub or server (not shown). Thus, the wireless communication via module 94 enables simple and easy installation of a given air delivery module 12 requiring only the interconnection of an air supply line 34 (or more than one air supply line 92a, 92b). The air supply 34 spins the impellor 62 to create and then store electricity for local use at the air delivery module 12 to obviate the need to run electrical wires to each air delivery module location. Moreover, the wireless communication module 94 enables remote control, such as via a host hub, for control of the array of air delivery modules 12.

The present invention uses the appropriate electronics and computer systems to carry out the present invention. The circuit boards 96 can carry the appropriate microprocessors, RAM and be powered by the batteries 88 to run the appropriate operating system to execute software for parsing sensor data to control direction of the air blower 32, receiving and providing instructions for manifold valve control, and the like. The appropriate software is used to assist the modules 12 with interconnection with other modules 12 in the system 10 so they may communicate with each other, as desired. Such computer and software functionality are so well-known that they do not need to be discuss in further detail herein.

Therefore, the system 10 of the present invention, is environment responsive where sensors 58 are used to efficiently control the collection of air flow in response to individual 16 presence or any other event or instruction. One set of sensors 58 (preferably three) controls the solenoid valve 56 to let the air through based on individual 16 activity for efficient energy use while another set of sensors 58 (preferably three) controls the direction of the air blower 32 air output for more accurate delivery of air into the space 14, such as toward a individual 16 or toward a particular environment location that requires air flow.

The aforesaid examples are only one of the optimal modes of execution of the present invention and common changes and substitutes made by technical personnel of this field within the technical proposal of this invention should be included in the protection scope thereof. It would be appreciated by those skilled in the art that various changes and modifications can be made to the illustrated embodiments without departing from the spirit of the present invention. All such modifications and changes are intended to be covered by the appended claims.

What is claimed is:

1. An environmental air flow system, comprising:
a supply of air;
an air conduit fluidly connected to the supply of air;
an air delivery module, comprising:
a housing in fluid communication with the air conduit to receive air flow therefrom; the housing including an air exit port to deliver air from the air conduit;
the housing being mounted to the support surface; the housing being configured to selectively actuate the air exit port to direct air in a desired direction.

2. The environmental air flow system of claim 1, further comprising:
a support surface;
wherein the air delivery module is mounted to the support surface via an electronically controlled pan and tilt mechanism.

3. The environmental air flow system of claim 1, wherein the air delivery module further includes an impellor blade carrying an array of magnets rotatably located in a path of air through the housing and a top cover carrying an array of wire coils having an electrical output wire; the actuation of the wire coils relative to the magnets generating electricity through the electrical output wire.

4. The environmental air flow system of claim 3, further comprising an energy storage device connected to the electrical output wire to receive and store energy created by the interaction of the magnets and the wire coils.

5. The environmental air flow system of claim 1, further comprising:
a plurality of air supply conduits;
a manifold having a valve therein; the manifold having multiple inputs and a single output;
the air supply conduits being respectively fluidly connected to the multiply inputs of the manifold;
the single output being fluidly connected to the housing.

6. The environmental air flow system of claim 5, further comprising:
an energy storage device;
the valve being electrically interconnected to and powered by the energy storage device whereby the valve controlling flow of air through the air delivery module.

7. The environmental air flow system of claim 1, further comprising:
at least one sensor electrically interconnected to and powered by an energy storage device and being configured and arranged to sense presence of an individual;
whereby detected presence of an individual by the sensor causes opening of the valve and flow of air into the unit.

8. The environmental air flow system of claim 1, further comprising:
at least one sensor electrically interconnected to and powered by an energy storage device and being configured and arranged to sense presence of an individual;
whereby detected presence of an individual in three dimensional space by the sensor causes direction of flow of air toward the individual.

9. The environmental air flow system of claim 6, wherein the energy storage device is a battery or array of batteries.

10. The environmental air flow system of claim 1, wherein the air delivery module is wirelessly connected to a controller hub or server.

11. The environmental air flow system of claim 1, wherein the system includes plurality of air delivery modules arranged in an array.

12. The environmental air flow system of claim 11, wherein the plurality of air delivery modules are wirelessly connected to each other.

13. The environmental air flow system of claim 3, wherein excess created electricity is routed back to the grid.

14. The environmental air flow system of claim 1, wherein the system is a heating, ventilation, and air conditioning system.
